(19) United States
(12) Patent Application Publication
(10) Pub. No.: US 2008/0215669 A1
(43) Pub. Date: Sep. 4, 2008

(54) System and Method for Peer-to-Peer Connection of Clients Behind Symmetric Firewalls

(76) Inventors: William Gaddy, Milford, PA (US); Chang Feng, Princeton, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 10/590,781

(22) PCT Filed: Mar. 9, 2005
(86) PCT No.: PCT/US05/07655

§ 371 Date: May 9, 2007

Related U.S. Application Data
(60) Provisional application No. 60/551,610, filed on Mar. 9, 2004.

(51) Int. Cl. G06F 15/16

(52) U.S. Cl. 709/203; 709/227

(57) ABSTRACT

A system and method for establishing and maintaining two-way peer-to-peer network communication between clients who are behind symmetric firewalls/NATs is presented (FIG. 7). In one exemplary embodiment, the inventive system discovery servers to ascertain the nature and port-mapping metrics of a given client's firewall/NAT. A systematic, multiple UDP Hole Punch method is employed for ports within a predicted range, and the source port of the first successful forwarding of an inbound packet is used by the client for subsequent outgoing traffic. Preferably, the method occurs symmetrically, thus ensuring that both clients' firewalls receive packets for which the source/destination ports and source/destination addresses fully-tuple-match with a previous client request originating from within the protected network, and therefore forwards packets to the respective clients successfully (peer-to-peer). In additional, the system and method allows monitoring, management, and prevention of connections by firewall/NAT administrators.

### CROSS-REFERENCE TO RELATED APPLICATIONS

This application claims the benefit of priority to U.S. Application No. 60/551,610 filed on Mar. 9, 2004, the entire disclosure of which is hereby incorporated by reference as if set forth at length herein.

### STATEMENT REGARDING FEDERALLY SPONSORED RESEARCH OR DEVELOPMENT

Not applicable

### REFERENCE OF A “MICROFICHE APPENDIX”

Not applicable

### BACKGROUND OF THE INVENTION

1. Field of Invention

The present invention relates to peer-to-peer network communication. More particularly, the present invention relates to systems, methods, apparatuses and computer program products for establishing direct Internet Protocol (IP) packet-based datagram communication between clients that are behind any combination of firewall/Network Address Translation (NAT) hardware/software that allow outgoing Universal Data Packet (UDP) traffic, without port-forwarding, and without relaying or proxy services.

2. Brief Description of the Prior Art

In certain types of services over IP packet-switched networks, it is highly desirable to allow peer-to-peer communication between end-users. It is also highly desirable for any given method to allow as many as possible combinations of clients to communicate with each other. The lack of a successful method to accomplish this is a major reason behind the lack of pervasive deployment of services such as video conferencing.

Video is characterized by large bandwidth requirements for each direction of communication—and it does not take many concurrent connections to overwhelm a typical circuit. It is therefore very desirable to avoid concentrations of this type of traffic at bottlenecks where physical or simple monetary constraints prevent the successful forwarding of essentially unlimited volumes of traffic.

Further, it is very desirable to minimize the time and efforts of specialized personnel required to support a given method. Some methods present problems of cost due to maintenance, setup, or security concerns.

There are several existing methods to traverse firewalls, in order to allow peer-to-peer modality for voice and video, including UDP Hole Punching (Internet Engineering Task Force (IETF) MidCom Working Group, P2PNAT (Peer-2-Peer Network Address Translation) Draft 2), and UPnP (Universal Plug and Play, Microsoft, et. al) but all of these have the problem in that the range of firewalls and combinations thereof that support peer-to-peer connectivity when using them are limited.

UPnP

Simply stated, any client behind a suitably-configured UPnP firewall/NAT can map ports directly to the outside internet, and thereby look to any other outside client as a server for those ports. Most firewalls, regardless of type, are configured to allow client/server connections. However, the flaw of this protocol is that it has only been embraced by consumer device manufacturers. There are, for example, no enterprise-class firewalls with UPnP support. Therefore, UPnP does not solve any problems for enterprise-to-enterprise connectivity, and only works in the cases where one or both peers are behind firewalls/NATs that support it.

UDP Hole Punching

UDP Hole Punching is more limiting. As envisaged by the IETF MidCom working group, both firewalls/NAts must be of a Cone-UDP type (this is generally specific to low-end consumer stateless firewalls). The probabilities of actual circumstance of these cases are multiplicative, and unfortunately, therefore, relatively rare-especially in the enterprise-to-consumer and enterprise-to-enterprise cases.

Other Methods

If one wants to enable video communication between any two arbitrary clients where both are behind symmetric firewalls (generally, enterprise-to-enterprise), there are three choices, all of which either engender the aforementioned concentrations of traffic and the expenses accruing thereto, or that require specialized installation, configuration, and/or active management and monitoring by qualified personnel of proprietary proxy/relay solutions for at least one of the peers' internal networks.

These three choices are:

1. To require at least one of the clients to be behind a firewall that has built-in or installed capability to support dynamic port-forwarding according to a common signaling and call origination protocol, such that said firewall can ensure that the used ports are forwarded in such a way that the client behind the forwarded firewall appears as a server to the client behind the other firewall, or;

2. To require proxy/relay services located in the demilitarized zone (DMZ) of one of the clients' firewalls, to allow communication between a peer behind the proxied firewall and one outside—where, again, the client behind the proxied service looks like a server to the other client, or;

3. To locate a proxy/relay service behind a known single address or group of addresses that is outside of both peer's firewalls to relay the traffic, wherein both clients are communicating with a common server—the relay.

The first choice is exemplified by the International Telecommunication Union's H.323 protocol (H.323) and IETF's Session Initiation Protocol (SIP). Both protocols are well-known connection and signaling protocols for establishing peer-to-peer connections over IP networks. H.323 and SIP are supported by many enterprise firewalls, but not all. Also, many mass-market consumer hardware and software firewalls do not support these protocols. Because these protocols use many and/or arbitrary TCP and UDP ports, these protocols are difficult to trace, difficult to analyze and monitor, and many firewall administrators simply turn these protocol capabilities off in the firewalls that do have native support for it rather than be tasked with monitoring and managing them. Furthermore, discoveries about security holes in the reference implementation of H.323 will undoubtedly result in this protocol being disabled by many administrators. In general, this method could work if there was a protocol that met the requirements for security, manageability, pervasiveness and adoption—but this is not the case with H.323 and SIP and no protocols are currently on the standards-track that satisfy all of the foregoing requirements.

The second choice has become the preferred method of managing peer-to-peer video services in the enterprise—however, the costs accruing to it are asymmetric. Because the second choice requires at least one client to be behind a firewall whose administrator has provided a video relay service in the DMZ (and at the costs associated with it), an all-too-defensible position from an IT Management perspective is that if video services are so necessary between “us” and “them”, why don't “they” absorb the cost of installing and maintaining a proxy/relay service? A common consequence is that no one ends up absorbing this expense.

The third choice is a natural consequence of the drawbacks of the first two: there are presently no interoperable, standards-based solutions which require less than significant expense that allow any two given clients behind any two symmetric firewalls to communicate with each other. If one could provide a third party relay service, and absolve individual end-user firewall administrators of this task, it would vastly simplify the administrators' overall architecture, equalize costs among end users, and provide a common service provider point. Unfortunately, the common point(s) are the root of the failure for this method to provide an cost-effective and scalable solution to video connectivity. In order to support such a solution for 100,000 concurrent two-way video conferences, each using (conservatively) 200 kBit each way, a central relay service must support 40,000 MBit circuit connectivity (4000 T1 circuits). For each additional user, another 400 kbit of capability must be added. Clearly, this is prohibitively expensive and does not scale well.

There appear to be no existing systems that can, at once, solve the stated problems of all of the above five methods (or combinations thereof) that prevent wide-spread adoption and usage by end-users, by simultaneously allowing true peer-to-peer, unproxied/unrelayed connections between all of the following:

Clients behind Cone or UPnP Firewalls/NATs to clients behind same;

Clients behind Cone or UPnP Firewalls/NAT's to clients on routable addresses;

Clients behind Cone or UPnP Firewalls/NAT's to clients behind Symmetric Firewalls/NATs; and

Clients behind Symmetric Firewalls/NATs to clients behind routable addresses;

Clients behind Symmetric Firewalls/NATs to clients behind Symmetric Firewalls/NATs.

### SUMMARY OF THE INVENTION

An object of the current invention is to allow peer-to-peer connectivity between clients, regardless of the type of firewall/NAT each is behind, whether Cone (see, FIG. 1), Port-Restricted Cone (see, FIG. 2), Symmetric (see, FIG. 3), or any combination thereof, without specific protocol support, installation of per-client server/services, or configuration of one or both clients' firewalls/NATs.

A further object of the current invention is to allow peer-to-peer connectivity between multiply-NAT-ted clients, some of said NATs being symmetric in nature, under limited circumstances, that was otherwise impossible with any other method or combinations of methods.

To achieve the first object, a method of establishing peer-to-peer connectivity between clients behind symmetric or cone firewalls/NATs must include discovering what the proper tuple (source/destination port, and source/destination address combination) is required to allow the client's firewall to forward packets to the client. In addition, the symmetric port translation behavior of firewalls can be further characterized as Symmetric Second Priority PAT (see, FIG. 4A) and Symmetric Pure PAT (see, FIG. 4B). Ultimately the calling client wants to establish two-way communication with a called client and to do so each much know what port was assigned to the address combination on both of the clients' NAT/PATs. FIG. 5 illustrates the problem inherent with achieving this is.

A first step to accomplish the first object is to obtain each client's publicly routable address and an example of a publicly routable, masqueraded port by contacting a discovery server. Since each separate destination server address (and, ultimately the called client's destination address) results in a different port mapping for Symmetric NAT/PATs, a second request to a second discovery server is indicated. This also simplifies the cases such as in FIG. 4A where in a very under-utilized NAT/PAT the port address translation will give a direct port mapping to the first internal user of a given port, but a masqueraded port for subsequent address contacts. It is thus ensured that the second and subsequent addressed requests will use masqueraded ports.

Referring to FIG. 5, the calling client retrieves this information from the discovery servers and sends the second tuple (combination of source/destination port, source/destination address) to the called client via a well-known, open, and agreed upon server. In response, the called client does the same for itself, and responds to the calling client with its second tuple. The called client also begins sending UDP packets to the reported source address and source port of the calling client. If the calling client is a Cone NAT, these packets will be delivered. If the calling client is behind a Symmetric NAT, the packets will not be delivered. In the meantime, when the calling client receives the called client's tuple, it, too will begin to send UDP packets to the called client's reported source address and source port. If the called client is behind a Cone NAT, these packets will be delivered. If the called client is behind a Symmetric NAT, the packets will not be delivered.

After a client receives an inbound packet, it knows the proper destination port of its peer, regardless of what type of firewall/NAT the other client is behind.

If one of the clients happens to be behind a Cone NAT, the first few attempts at sending to the original destination port will succeed. When the firewall forwards the packet, the client will receive it, take note of the inbound packet's source port, and will then know to send all traffic to that destination port. In addition, the client will send a success packet to indicate to the other client that it can stop sending discovery packets. Up to this stage, the process may be much like a normal UDP Hole Punch combined with a connection-reversal. The next part of the process departs significantly from normal UDP Hole Punch methods.

In the case where both clients are behind symmetric NATs, neither client will receive UDP packets.

When a certain period of time has elapsed before a client has received one of these UDP packets, the client will begin to send its packets not to a single destination port, but to an entire range of ports (“Shotgun”). Most firewall/NATs that perform port masquerading use a simple algorithm (usually simple addition) to assign ports to clients sending UDP requests. A wide enough range will likely “find” the masqueraded port of the other peer by brute force. When the firewall forwards the packet, the client will receive it, take note of the inbound packet's source port, and will then know to send all traffic to that destination port. If both clients are behind symmetric firewalls, they both will send this series of UDP packets to “find” the active port, and both clients will discover the active destination port of their peer. FIG. 6 is a fall traffic and tuple diagram of this process, including the important firewall state table tuples at each point of the exchange. Note: FIG. 6 omits the second discovery server contact for brevity. In addition, the “shotgun” width described in the figure is limited to the range of the original port through the original port plus a value, such as 8. Preferred embodiments use a much wider range, for example, minus 16 through plus 32.

When a client gets a positive indication of an incoming packet, it sends a success packet response to the sender to indicate that it can stop sending discovery packets. This always succeeds because the client sending the response now always knows what destination port to send to. FIG. 7 depicts a flowchart of the entire protocol exchange as described.

Subsequently, all payload is sent from a given client using this identified port.

To achieve the second object of the invention, both clients use UPnP support, if available, as a first step to directly map ports, thus ensuring a connection reversal. The further ability to match source port and masqueraded destination ports offers the ability to communicate with symmetric firewalls that have been manually configured to not allow outgoing UDP requests on the dynamic port range. FIG. 8 depicts a flowchart of the entire protocol exchange including the UPnP steps.

### BRIEF DESCRIPTION OF THE DRAWINGS

Exemplary embodiments of the present invention will now be briefly described with reference to the following drawings:

FIG. 1 shows a representation of requests and responses in a system in which a client is behind a Cone NAT/PAT.

FIG. 2 shows a representation of requests and responses in a system in which a client is behind a Port-Restricted Cone NAT/PAT.

FIG. 3 shows a representation of requests and responses in a system in which a client is behind a Symmetric NAT/PAT.

FIG. 4A shows a representation of requests and responses in a system in which a client is behind a second-priority masquerading NAT/PAT.

FIG. 4B shows a representation of requests and responses in a system in which a client is behind a pure masquerading NAT/PAT.

FIG. 5A shows a representation of the initial discovery requests and responses in a connection reversal failure between clients behind symmetric NAT's.

FIG. 5B shows a representation of a connection reversal failure between clients behind symmetric NAT's.

FIG. 6A shows a representation of an initial stage of a shotgun exchange between clients behind symmetric NAT/PATs.

FIG. 6B shows a representation of a later stage of a shotgun exchange between clients behind symmetric NAT/PATs.

FIG. 7 shows a flowchart of discovery, message exchange and the shotgun process.

FIG. 8 shows a flowchart of discovery, message exchange and the shotgun process using UPnP.

FIG. 9 shows an additional aspect of the present invention in accordance with the teachings herein.

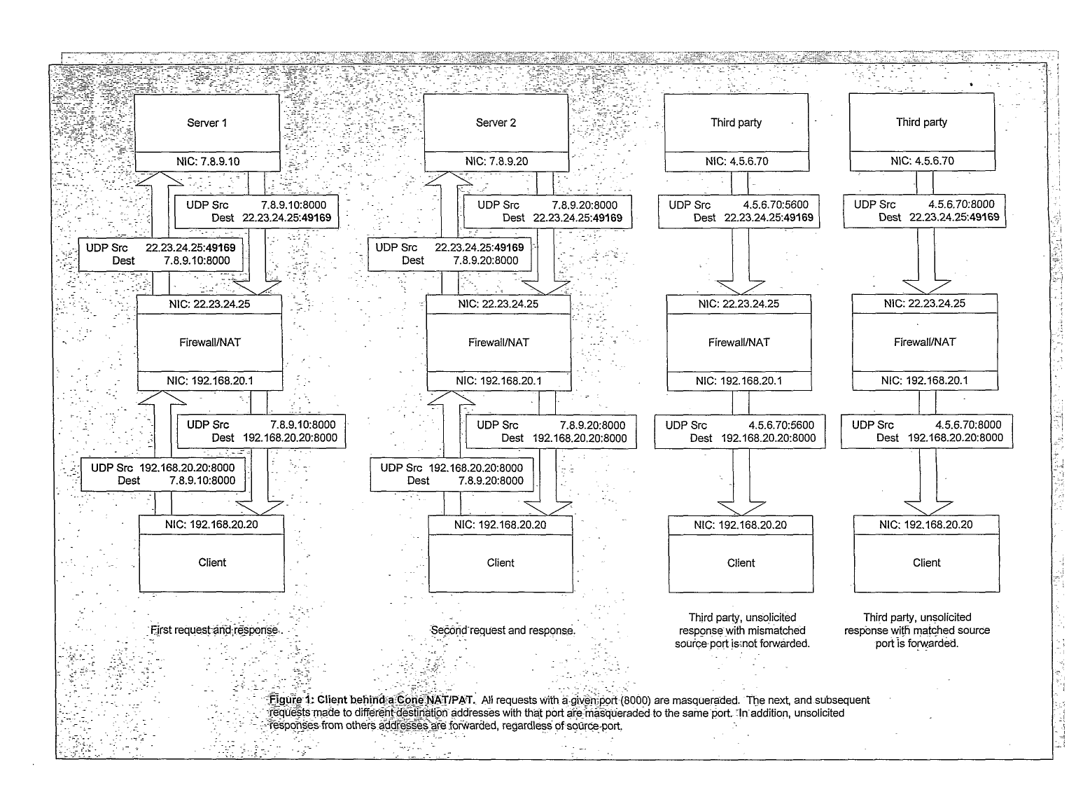

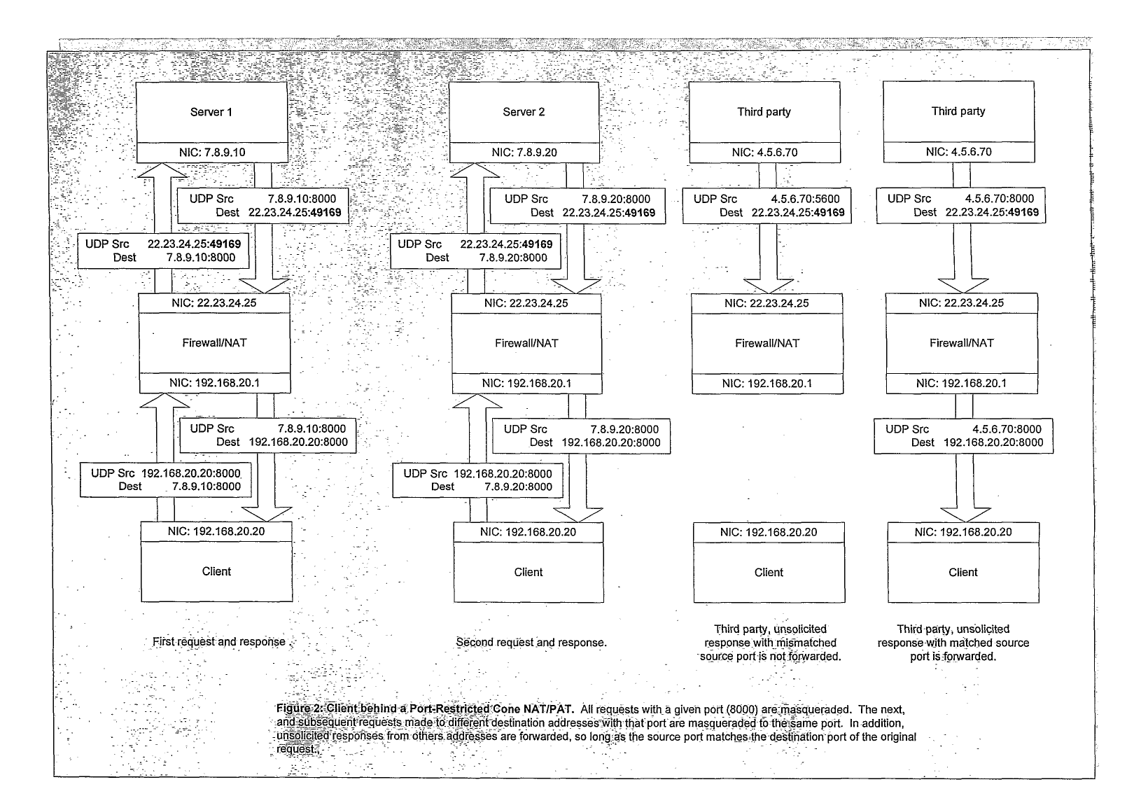

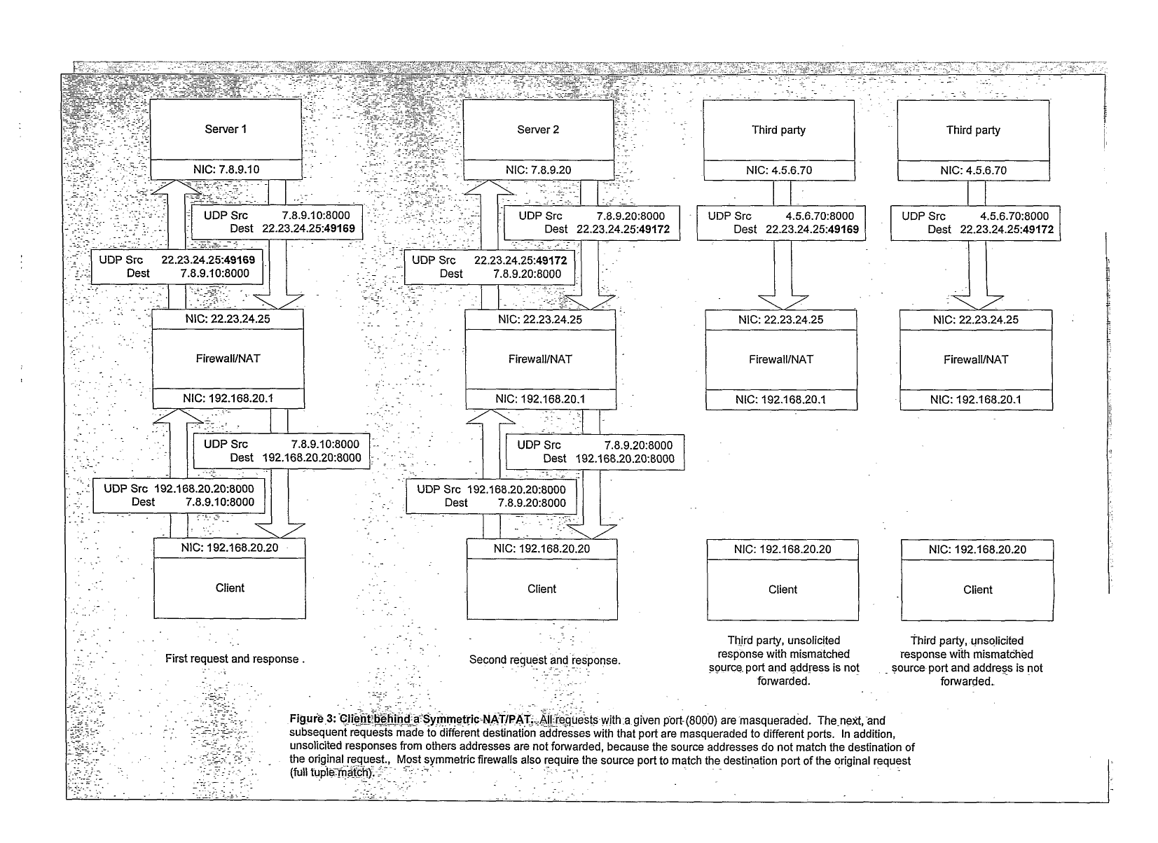

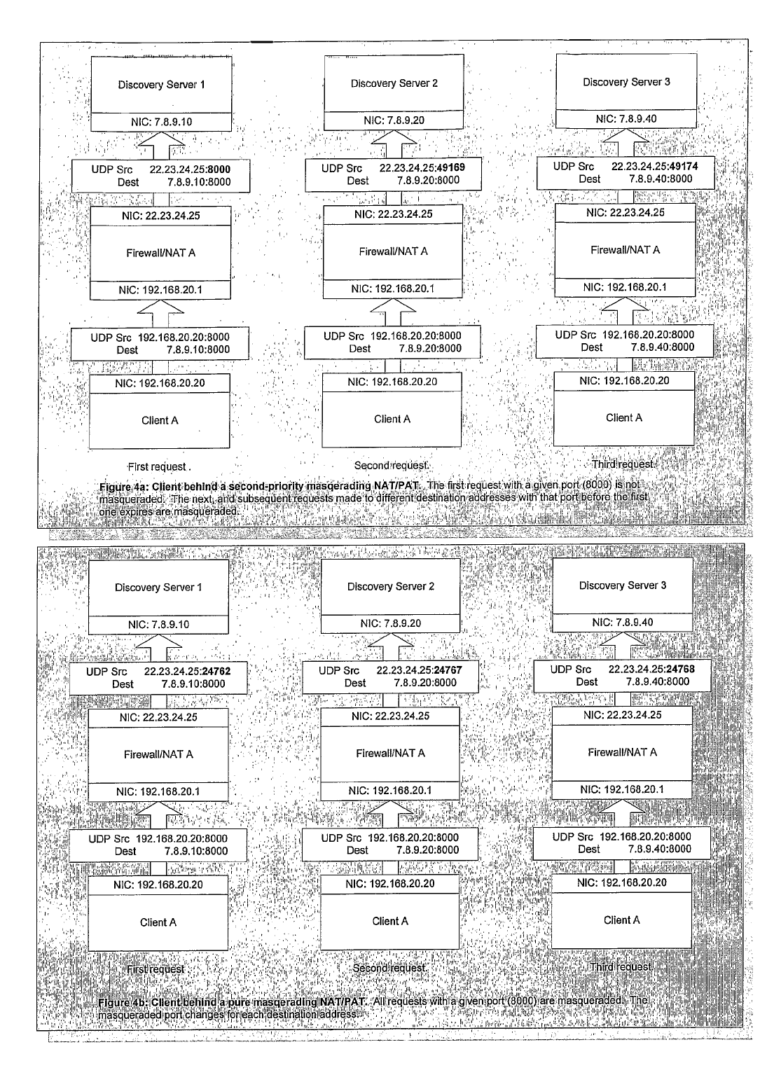

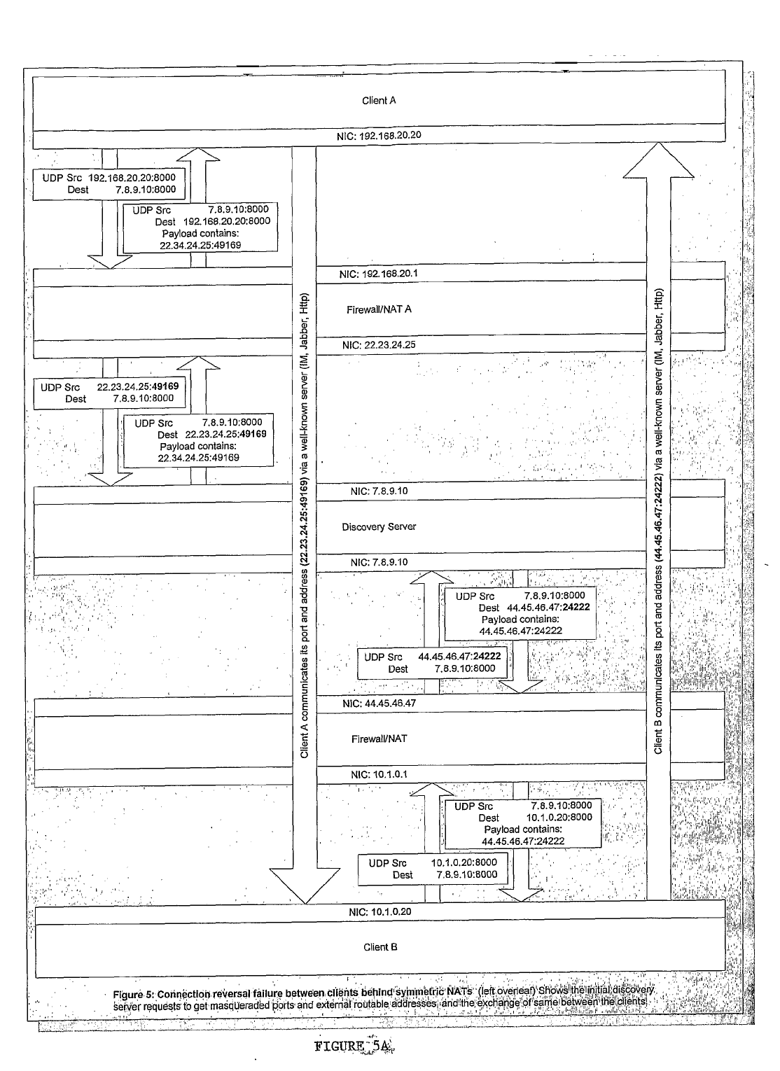

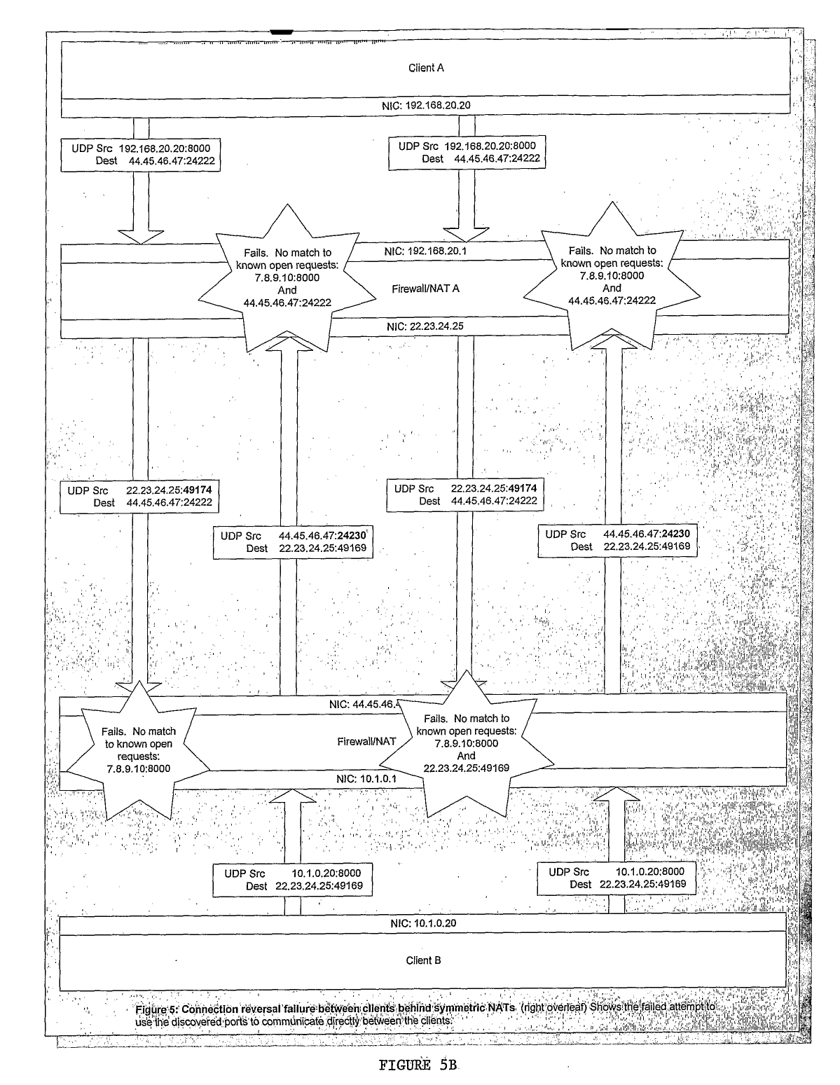

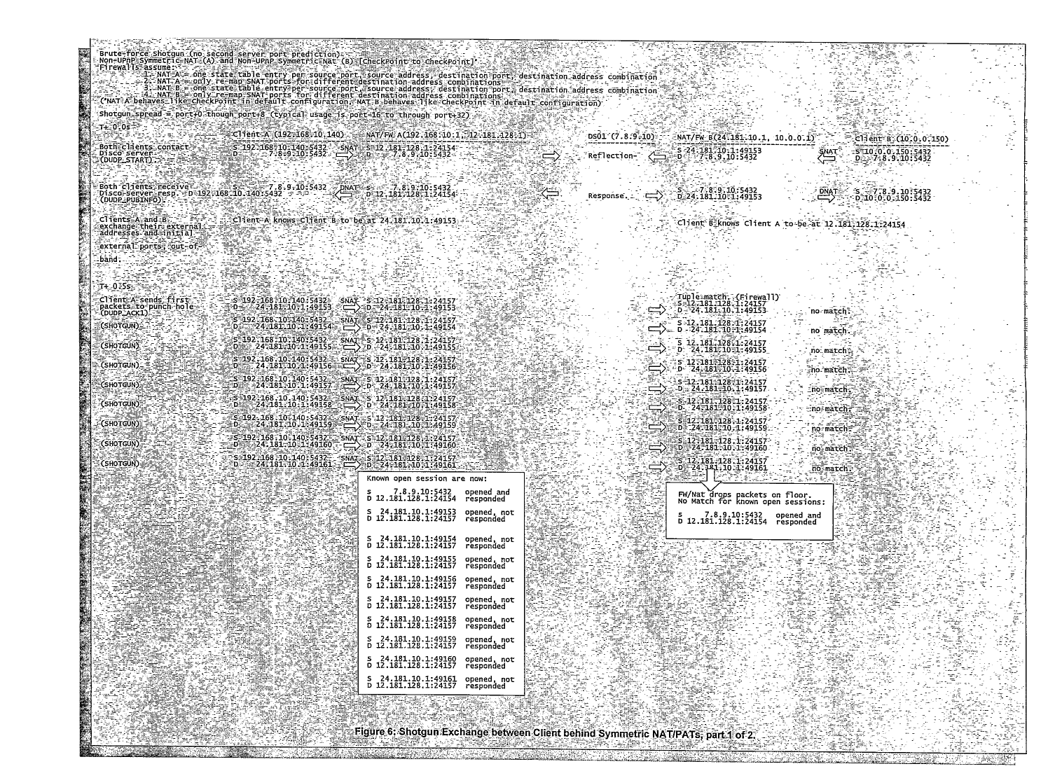

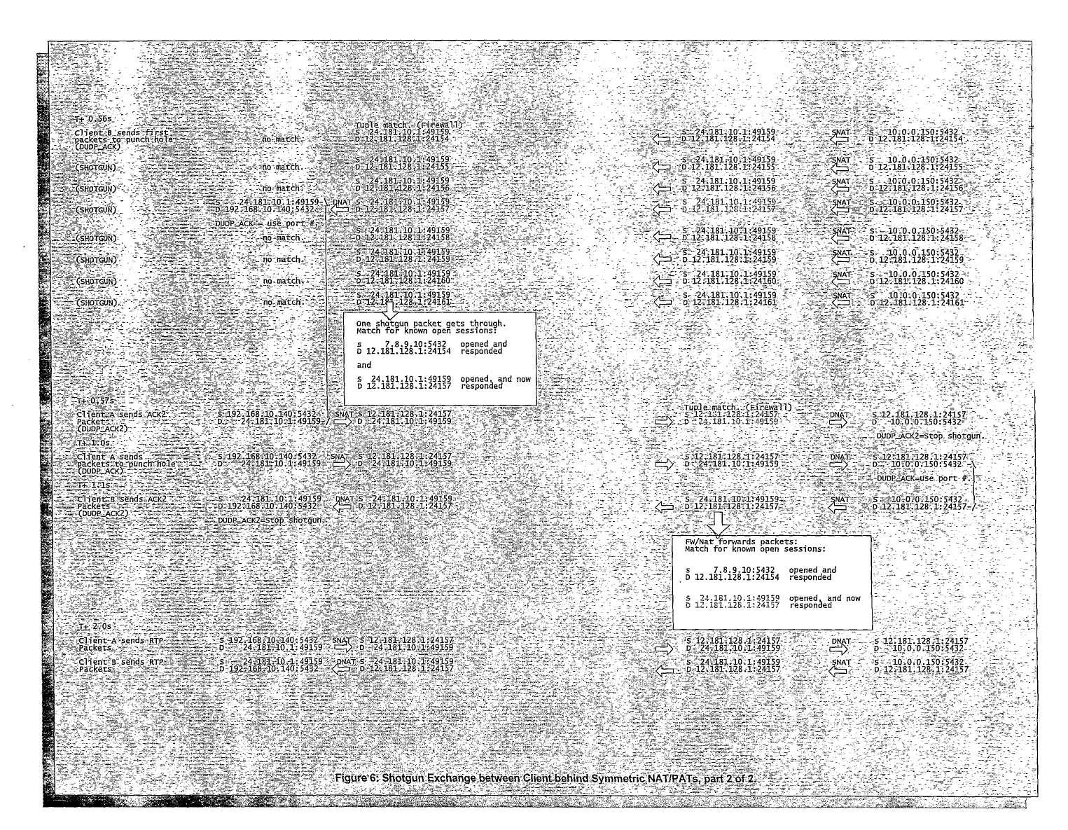

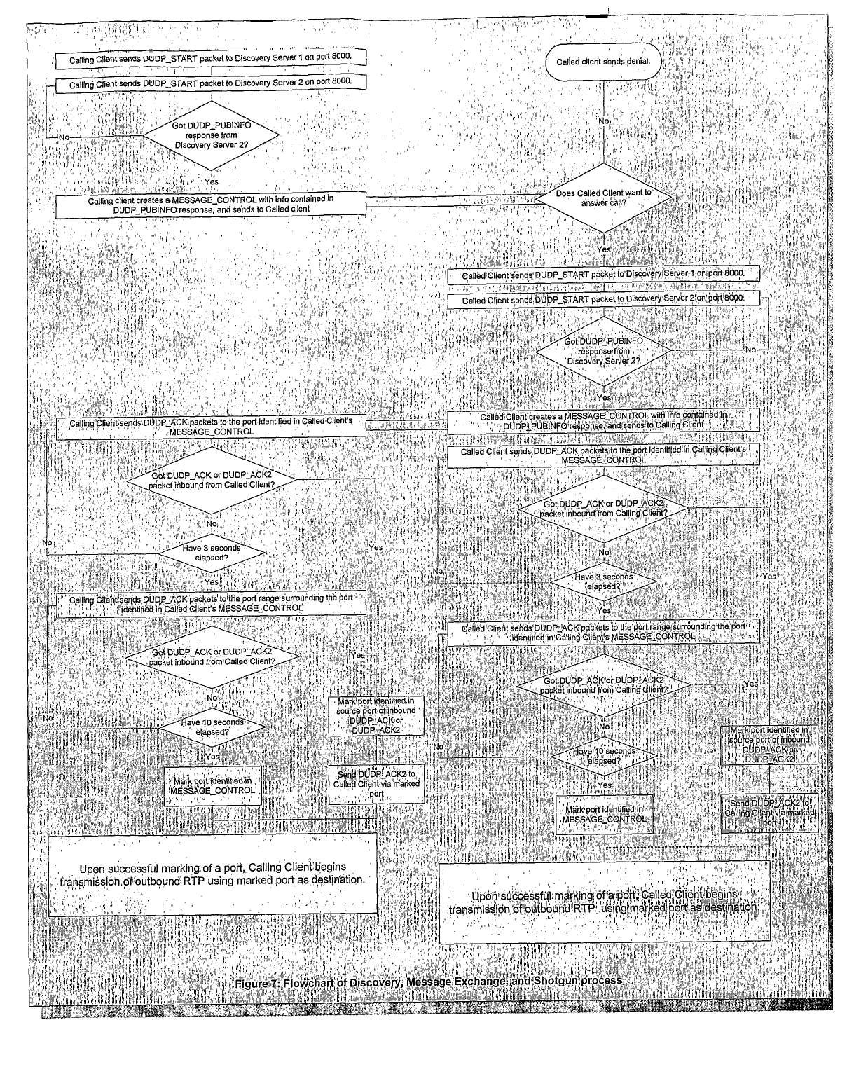

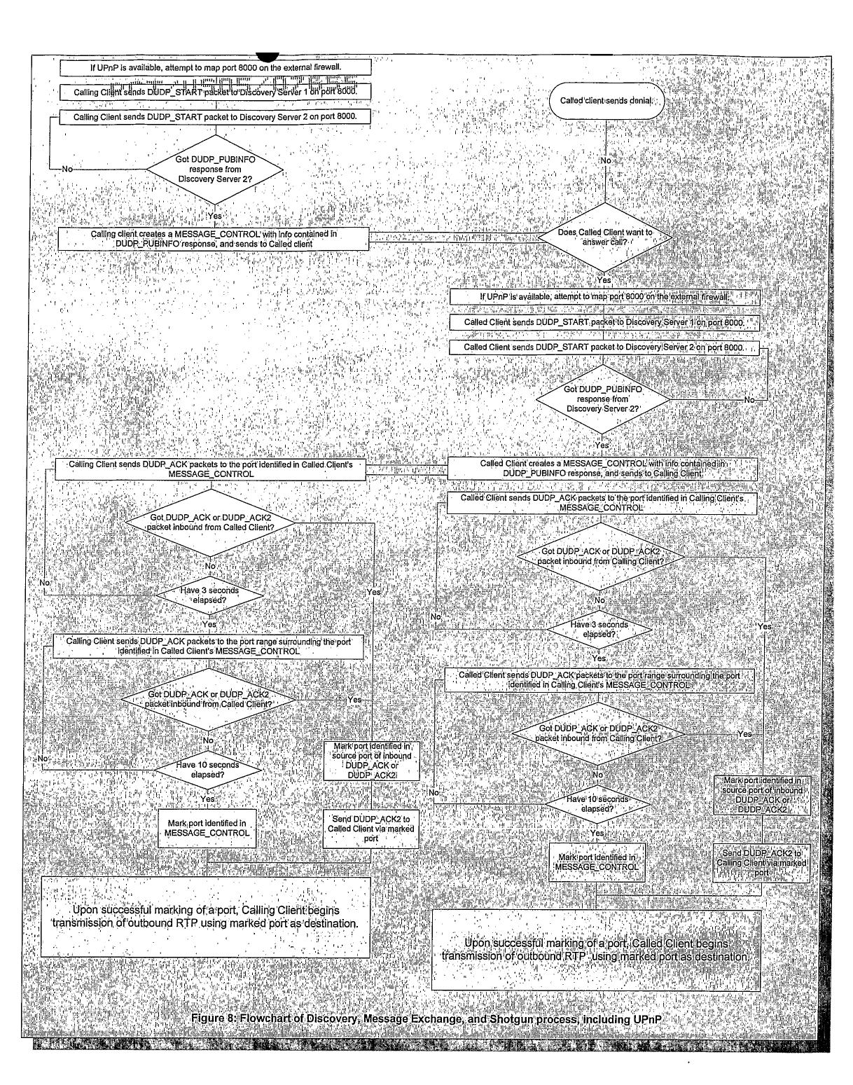

### DETAILED DESCRIPTION OF THE INVENTION

The aspects, features and advantages of the present invention will become better understood with regard to the following description with reference to the accompanying drawings. What follows are preferred embodiments of the present invention. It should be apparent to those skilled in the art that the foregoing is illustrative only and not limiting, having been presented by way of example only. All the features disclosed in this description may be replaced by alternative features serving the same purpose, and equivalents or similar purpose, unless expressly stated otherwise. Therefore, numerous other embodiments of the modifications thereof are contemplated as falling within the scope of the present invention as defined herein and equivalents thereto. During the course of this description like numbers may be used and will identify like elements according to the different views that illustrate the invention.

An exemplary and preferred embodiment of the present invention comprises the following methodology:

Two or more discovery servers are situated at different addresses, each listening at a series of well-known UDP ports, each of which will respond to well-formed requests from clients with a response containing the requesting client's public address and public port; and two clients who will execute the following steps of the method, in order:

The calling client determines if the local NAT, if present, supports UPnP. The calling client also determines if the local NAT, if present, supports UPnP client-activated port forwarding. If the foregoing is true, the calling client attempts to map the source port to the destination port identically and directly across the NAT via UPnP

The calling client retrieves its private address, private source port, public address, public source port, and public destination port tuple by contacting and receiving response from a first discovery server at a first address via a well-known source and destination port (DUDP_START request, DUDP_PUBINFO response).

The calling client retrieves its private address, public address, private destination port, and public destination port tuple by contacting and receiving response from a second discovery server at a second address via the same well-known source and destination port as in 1 (DUDP_START request, DUDP_PUBINFO response).

The calling client will send the contents of its received second tuple, the differential of the first discovery-reported source port and second discovery-reported source port to the called client via an established, mutually agreed-upon server for this purpose (MESSAGE_CONTROL).

If the called client is not willing to receive calls from the sender, an abort is signaled to the sender and the process stops.

If the called client is willing to receive calls from the sender, the called client determines if the local NAT, if present, supports UPnP. Next, the called client determines if the local NAT, if present, supports UPnP client-activated port forwarding. If the foregoing is true, the called client attempts to map the source port to the destination port identically and directly across the NAT via UPnP.

The called client will retrieve the calling client's tuple (MESSAGE_CONTROL), and its own source address, public address, source port, and destination port tuple by contacting and receiving response from a first discovery server via a well-known source and destination port. (DUDP_START request, DUDP_PUBINFO response)

The called client will retrieve its source address, public address, source port, and destination port tuple by contacting and receiving response from a second discovery server at a second address via the same well-known source and destination port as indicated above. (DUDP_START request, DUDP_PUBINFO response).

The called client will send the contents of its received second tuple, the differential of the first discovery-reported source port and second discovery-reported source port, and any desired modifications to the calling client's tuple to the calling client via the established, mutually agreed-upon server.

The called client will then begin a periodic send of UDP packets (DUDP_ACK) to the calling client's address and source port according to the tuple reported to it by the caller's MESSAGE_CONTROL when in good receipt.

The calling client, upon good receipt of a tuple response (MESSAGE_CONTROL) from the called client, will then begin a periodic send of UDP packets (DUDP_ACK) to the called client's address and source port according to the tuple reported to it by the called client's MESSAGE_CONTROL.

If the calling client receives a DUDP ACK, it will take note of the source port identified in the IP header of said packet, and use it for subsequent outgoing DUDP_ACK packets, mark this port for further payload traffic, and also send a DUDP_ACK2 packet to this destination port. If no DUDP_ACK packet is received within a certain period of time, a series of DUDP_ACK packets, each with a destination port within a range beyond and contiguous to a predicted value extrapolated by the called client's differential, is sent periodically instead of a single packet to a single destination port. Subsequent, repeated transmissions of this series may move the port range window with each iteration.

If the called client receives a DUDP ACK packet, it will take note of the source port identified in the IP header of the packet, and use it for subsequent outgoing DUDP_ACK packets, mark this port further payload traffic, and also send a DUDP_ACK2 packet to this port. If no DUDP_ACK packet is received within a certain period of time, a series of DUDP_ACK packets, each with a destination port within a range beyond and contiguous to a predicted value extrapolated by the calling client's differential, is sent periodically instead of a single packet to a single destination port. Subsequent, repeated transmissions of this series may move the port range window with each iteration.

If the calling client either times out, or receives a DUDP_ACK2 packet, it assumes that it has a properly marked destination port, using the reported called client's reported tuple source port as a destination port failover value.

If the called client either times out, or receives a DUDP_ACK2 packet, it assumes that it has a properly marked destination port, using the reported calling client's reported tuple source port as a destination port failover value.

When the calling client has a properly marked destination port, it will begin to send payload data to this port to the called client.

When the called client has a properly marked destination port, it will begin to send payload data to this port to the calling client.

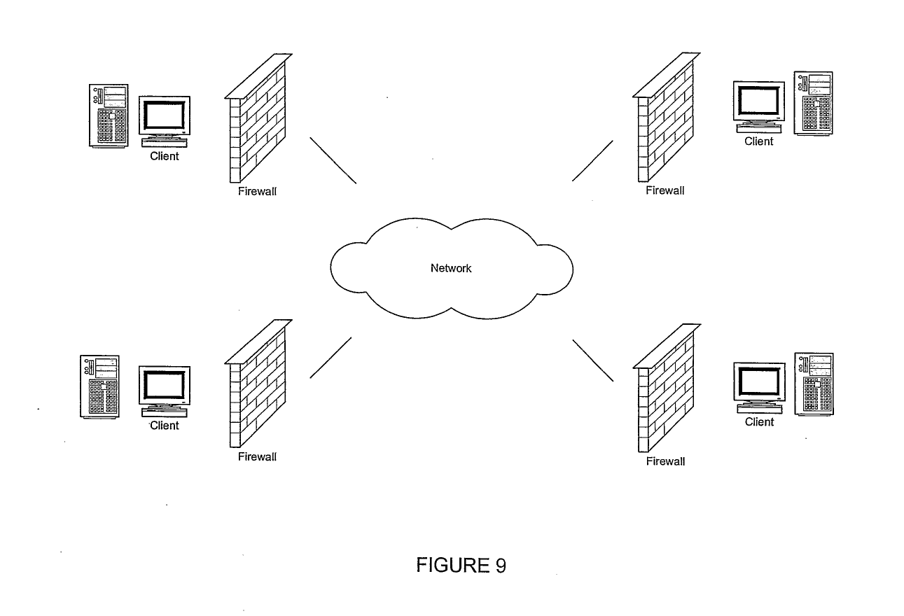

FIG. 9 is a high-level block diagram of an exemplary system for providing peer-to peer communication over a communications network according to the principles of this invention. Generally, the system includes a communications network(s) and any number of clients coupled to the communications network(s). The clients interface with the communication network(s) behind associated firewall technology.

The communications network(s) can take a variety of forms, including but not limited to, a local area network, the Internet or other wide area network, a satellite or wireless communications network, a commercial value added network (VAN), ordinary telephone lines, or private leased lines. The communications network used need only provide fast reliable data communication between endpoints.

Each of the clients can be any form of system having a central processing unit and requisite video and/or audio capabilities, including but not limited to, a computer system, main-frame system, super-mini system, mini-computer system, work station, laptop system, handheld device, mobile system or other portable device, etc.

The firewall technology include those described herein as well as other equivalent hardware and/or software techniques.

Having now described preferred embodiments of the invention, it should be apparent to those skilled in the art that the foregoing is illustrative only and not limiting, having been presented by way of example only. All the features disclosed in this specification (including any accompanying claims, abstract, and drawings) may be replaced by alternative features serving the same purpose, and equivalents or similar purpose, unless expressly stated otherwise. Therefore, numerous other embodiments of the modifications thereof are contemplated as falling within the scope of the present invention as defined by the appended claims and equivalents thereto.

For example, the present invention may be implemented in hardware or software, or a combination of the two. Preferably, aspects of the present invention are implemented in one or more computer programs executing on programmable computers that each include a processor, a storage medium readable by the processor (including volatile and non-volatile memory and/or storage elements), at least one input device and one or more output devices. Program code is applied to data entered using the input device to perform the functions described and to generate output information. The output information is applied to one or more output devices.

Each program is preferably implemented in a high level procedural or object oriented programming language to communicate with a computer system, however, the programs can be implemented in assembly or machine language, if desired. In any case, the language may be a compiled or interpreted language.

Each such computer program is preferably stored on a storage medium or device (e.g., CD-ROM, ROM, hard disk or magnetic diskette) that is readable by a general or special purpose programmable computer for configuring and operating the computer when the storage medium or device is read by the computer to perform the procedures described in this document. The system may also be considered to be implemented as a computer-readable storage medium, configured with a computer program, where the storage medium so configured causes a computer to operate in a specific and predefined manner. For illustrative purposes the present invention is embodied in the system configuration, method of operation and product or computer-readable medium, such as floppy disks, conventional hard disks, CD-ROMS, Flash ROMS, nonvolatile ROM, RAM and any other equivalent computer memory device. It will be appreciated that the system, method of operation and product may vary as to the details of its configuration and operation without departing from the basic concepts disclosed herein.

What is claimed is:

1. A method of communicating over a network between a calling client behind a first firewall and a called client behind a second firewall, the method comprising the steps of:
providing first and second discovery servers coupled to said network; each of said discovery servers containing address and port information associated with said calling and called clients;
at said calling client:
retrieving from said first and second discovery servers said calling client's address and port;
generating and sending to said called client a first data message comprising said calling client's address and port;
at said called client:
receiving said calling client's first data message and determining said calling client's address and port therefrom;
retrieving from said first and second discovery servers said called client's address and port;
generating and sending to said calling client a second data message comprising said called client's address and port;
generating and sending a first discovery data packet to said calling client's address and port;
at said calling client:
receiving said called client's second data message and determining said called client's address and port therefrom;
generating and sending a second discovery data packet to said called client's address and port;
wherein if, after a predetermined time period said calling or called client does not receive said first or second discovery data packet then: sending a plurality of third discovery data packets to a predefined range of ports until an active address associated with said calling or called client is discovered, and receiving said third discovery data packet at said discovered address; otherwise, receiving said first and second discovery data packet at said calling and called address, respectively.

2. The method as in claim 1 wherein the method further comprises:
providing a server coupled to said network; said server being associated with said calling and called clients;
at said calling client:
sending to said called client said first data message comprising said calling client's address and port via said server;
at said called client:
sending to said called client said second data message comprising said called client's address and port via said server.

3. The method as in claim 1 wherein the first and second discovery servers include private and public port and address information associated with said calling and called clients.

4. The method as in claim 1 wherein the first discovery server includes first port and address information associated with said calling and called clients and said second discovery server includes second port and address information associated with said calling and called clients.

5. The method as in claim 4 wherein the first message generation steps further comprise: determining a first differential value between the calling client's first port and the second port; and generating said first data packet comprising said calling client's address and port and said differential value.

6. The method as in claim 4 wherein the second message generation steps further comprise: determining a second differential value between the called client's first port and the second port; and generating said second data packet comprising said called client's address and port and said second differential value.

7. The method as in claim 6 wherein said second data packet further includes modifications to the calling client's first data packet.

8. The method as in claim 1 wherein the predefined range of ports is extrapolated from the first or second differential values.

9. The method as in claim 1 wherein said data packets are Universal Data Packets.

10. The method as in claim 1 wherein said first and second firewall include Symmetric or Cone Firewall/Network Address Translation.

11. The method as in claim 1 wherein said first and second firewall include Symmetric or Cone Network Address Translation/Port Address Translation.

12. The method as in claim 1 wherein said first and second firewall said first and second firewall include UPnP, UPnP, Network Address Translation/Port Address Translation, Multi-Network Address Translation or any combination of the foregoing.

13. A system for communicating over a network comprising:
a calling client associated with a first firewall; said calling client coupled to said network;
a called client associated with a second firewall; said calling and called client coupled to said network;
first and second discovery servers coupled to said network; each of said discovery servers containing address and port information associated with said calling and called clients;
said calling client configured to:
retrieve from said first and second discovery servers said calling client's address and port;
generate and send to said called client a first data message comprising said calling client's address and port;
said called client configured to:
receive said calling client's first data message and determining said calling client's address and port therefrom;
retrieve from said first and second discovery servers said called client's address and port;
generate and send to said calling client a second data message comprising said called client's address and port;
generating and sending a first discovery data packet to said calling client's address and port;
said calling client further configured to:
receive said called client's second data message and determining said called client's address and port therefrom;
generate and send a second discovery data packet to said called client's address and port;
wherein said calling or called client is further configured to:
if, after a predetermined time period said calling or called client does not receive said first or second discovery data packet then: send a plurality of third discovery data packets to a predefined range of ports until an active address associated with said calling or called client is discovered, and receive said third discovery data packet at said discovered address; otherwise, receive said first and second discovery data packet at said calling and called address, respectively.

14. The method as in claim 13 wherein the system further comprises:
a server coupled to said network; said server being associated with said calling and called clients;
said calling client configured to send to said called client said first data message comprising said calling client's address and port via said server;
said called client configured to send to said called client said second data message comprising said called client's address and port via said server.

15. The method as in claim 13 wherein the first and second discovery servers include private and public port and address information associated with said calling and called clients.

16. The method as in claim 13 wherein the first discovery server includes first port and address information associated with said calling and called clients and said second discovery server includes second port and address information associated with said calling and called clients.

17. The method as in claim 16 wherein the first message generation steps further comprise: determining a first differential value between the calling client's first port and the second port; and generating said first data packet comprising said calling client's address and port and said differential value.

18. The method as in claim 16 wherein the second message generation steps further comprise: determining a second differential value between the called client's first port and the second port; and generating said second data packet comprising said called client's address and port and said second differential value.

19. The method as in claim 18 wherein said second data packet further includes modifications to the calling client's first data packet.

20. The method as in claim 13 wherein the predefined range of ports is extrapolated from the first or second differential values.

21. The method as in claim 13 wherein said data packets are Universal Data Packets.

22. The method as in claim 13 wherein said first and second firewall include Network Address Translation/Port Address Translation.

23. The method as in claim 13 wherein said first and second firewall include Symmetric or Cone Firewall/Network Address Translation or any combination of the foregoing.

24. The method as in claim 13 wherein said first and second firewall include UPnP, Network Address Translation/Port Address Translation, Multi-Network Address Translation or any combination of the foregoing.
